(19) United States
(12) Patent Application Publication
(10) Pub. No.: US 2008/0309944 A1
(43) Pub. Date: Dec. 18, 2008

(54) Quantitative phase-contrast digital holography method for the numerical reconstruction of images, and relevant apparatus

(75) Inventors: Pietro Ferraro, Rome (IT); Domenico Alfieri, Rome (IT); Sergio De Nicola, Rome (IT); Andrea Finizio, Rome (IT); Giovanni Pierattini, Rome (IT)

Correspondence Address: ARENT FOX LLP, 1050 CONNECTICUT AVENUE, N.W., SUITE 400, WASHINGTON, DC, 20036, US

(73) Assignee: CONSIGLIO NAZIONALE DELLE RICERCHE

(21) Appl. No.: 11/785,286

(22) Filed: Apr. 17, 2007

(30) Foreign Application Priority Data
Apr. 21, 2006 (IT) RM2006A000226

(51) Int. Cl. G01B 9/021; G03H 1/08

(52) U.S. Cl. 356/457; 359/9

(57) ABSTRACT

The invention concerns a quantitative phase-contrast digital holography method for the numerical reconstruction of images, comprising the following steps: A. acquiring a digital hologram of an investigated object; B. reconstructing the digital hologram in a reconstruction plane; C. reconstructing the complex field for the digital hologram; D. obtaining the phase map starting from the complex field; the method being characterised in that it further comprises the following steps:
E. applying to the digital matrix of any step A, B, C a shear sₓ and/or s_{y} respectively along directions x and/or y;
F. subtracting the matrix obtained in step E from the starting matrix of step E, or vice versa;
G. integrating the obtained matrix along directions x and/or y;
H. calculating at least a defocus aberration term;
I. subtracting said at least a term calculated in step H from the matrix obtained in step G,
   the steps G to I being subsequent to step D.

The invention further concerns a digital holography apparatus which implements the method of the invention.

The present invention concerns a quantitative phase-contrast digital holography method for the numerical reconstruction of images, and relevant apparatus.

More in detail, by the method of the present invention the reconstructed wave front and its replica, obtained digitally from a numerical shift in the image plane, can be subtracted one from the other to yield a shear interferogram from which the phase map of the object can be completely recovered, eliminating firstly the defocus aberration and possibly all the main aberrations. The invention concerns also the relevant apparatus of digital holography.

Quantitative phase-contrast microscopy (QPM) is a highly demanding experimental process used in various disciplines from semiconductor industries to biology.

Among several that can be used, two major categories exist for full-field, quantitative phase microscopy.

The first is related to the use of non-interferometric methods with or without the use of polarization components to determine the optical phase retardation of transparent objects. That approach has been used successfully to measure refractive indices of phase objects such as optical fibres and biological cells [1,2].

The alternative is the use, for example, of interferometric approaches such as digital holography (DH), which is used for biological objects [3-9] or equally well for silicon micro-electromechanical system (MEMS) structures [10,11].

Recently, other approaches have built up a new method, spectral-domain optical coherence phase microscopy, that is especially useful for studying dynamic phase objects [12-14].

In such methods of the prior art, it is needed more than one image is needed to recover the quantitative phase of objects under investigation by conventional phase-shifting interferometry, and this is a series of limitations on the investigation of dynamic processes.

To recover quantitative phase in DH, it is necessary to remove from the reconstructed phase map the additive contributions (CAF) due to the effects of the optical aberration which are typical of the experimental apparatus of holographic recording. Typically it is needed taking into account the aberration, so-called defocusing aberration, due to the objective of the microscope which introduces from the numerical point of view quadratic correction to the phase map of the object under examination. Different strategies can be adopted to obtain the corrected phase map. However, from the conceptual point of view, the CAF are removed by subtracting the phase map obtained from a synthetic or a real digital hologram.

In the case considered by Cuche et al. [15] a correcting phase mask is applied to perform a digital adjustment starting from the exact knowledge of some optical parameters (focal lengths, distances, etc.).

In one of the methods proposed by Ferraro et al [16], the correcting phase mask is obtained by a second digital hologram of a reference plane surface in proximity to the object. The same general concept underlies the work of Joo et al. [14] in which the correcting phase factor is removed by use of the reflection at a plane surface of a cover glass acting as a Mirau interferometer. Therefore, in all the cases discussed here, the quantitative phase is obtained conceptually by subtraction of two phase maps via optical [14], synthetic [15,16], or two wave fronts in a manner resembling holographic interferometry [16].

It is object of the present invention to provide a quantitative phase-contrast digital holography method for the numerical reconstruction of images which solves the problems of the prior art.

It is subject matter of the present invention a quantitative phase-contrast digital holography method for the numerical reconstruction of images, comprising the following steps:

A. acquiring a digital hologram of an investigated object;
B. reconstructing the digital hologram in a reconstruction plane;
C. reconstructing the complex field for the digital hologram;
D. obtaining the phase map starting from the complex field;
the method being characterised in that it further comprises the following steps:
E. applying to the digital matrix of any step A, B, C a shear sₓ and/or s_{y} respectively along directions x and/or y;
F. subtracting the matrix obtained in step E from the starting matrix of step E, or vice versa;
G. integrating the obtained matrix along directions x and/or y;
H. calculating at least a defocus aberration term;
I. subtracting said at least a term calculated in step H from the matrix obtained in step G,
the steps G to I being subsequent to step D.

It is another specific subject-matter of the invention a quantitative phase-contrast digital holography method for the numerical reconstruction of images, characterised in that it comprises the following steps:

AA. acquiring two digital holograms of an investigated object, which present a shear sₓ and/or s_{y} respectively along directions x and/or y one with respect to the other;
BB. subtracting one from the other the two digital holograms or their complex field or phase reconstruction, obtaining finally the relevant phase map;
GG. integrating the obtained matrix along directions x and/or y;
HH. calculating at least a defocus aberration term;
II. subtracting said at least a term calculated in step H from the matrix obtained in step GG,
the steps GG to II being subsequent to step BB.

Preferably according to the invention, the shear is applied directly to the digital hologram of step A.

Preferably according to the invention, the shear is applied directly to the digital hologram of step B.

Preferably according to the invention, the shear is applied directly to the digital hologram of step C.

Preferably according to the invention, said reconstruction plane is the image plane at distance d from the object.

Preferably according to the invention, said reconstruction plane is the hologram plane.

Preferably according to the invention, in step G, or in GG, the phase distribution of the object φ_{O}(x+Δx,y+Δy) in the point (x+Δx,y+Δy) can be determined with finite-difference approximation, i.e.:

φ_{O}(x+Δx,y+Δy)≈φ_{O}(x,y)+Δφ_{O}(x,y)Δx+Δφ_{O}(x,y)Δy

by means of standard numerical integration procedures.

Preferably according to the invention, sₓ and/or s_{y}=1 pixel.

Preferably according to the invention, said at least an aberration term is calculated on the basis of the information of the same digital matrix obtained after the subtraction or integration.

Preferably according to the invention, an aberration term is calculated by a linear fit.

Preferably according to the invention, more terms are calculated by polynomial fit.

Preferably according to the invention, before step G, or before step GG, a low-pass filter is applied.

It is another specific subject-matter of the invention an apparatus of digital holography, comprising a CCD camera suited to acquire digital holograms, as well as an electronic elaboration unit of such digital holograms, characterised in that said electronic elaboration unit carries out on an acquired digital hologram the method according to the invention in order to obtain a phase map devoid of aberration disturbances due to the apparatus optics.

It is another specific subject-matter of the invention an apparatus comprising two CCD cameras suited to acquire digital holograms, as well as an electronic elaboration unit of such digital holograms, characterised in that said two CCD cameras acquires directly two holograms which present a shear one with respect to the other, said electronic elaboration unit carrying out the method according to the invention in order to obtain the phase map devoid of aberration disturbances due to apparatus optics.

The invention will be now described, by way of illustration and not by way of limitation, by particularly referring to the drawings of the enclosed Figures, in which:

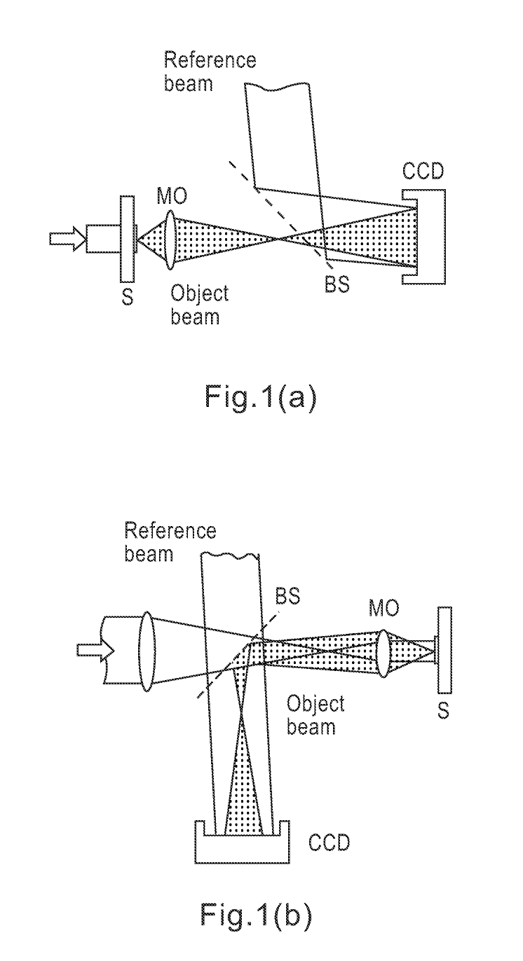

FIG. 1 shows a digital holography experimental apparatus.

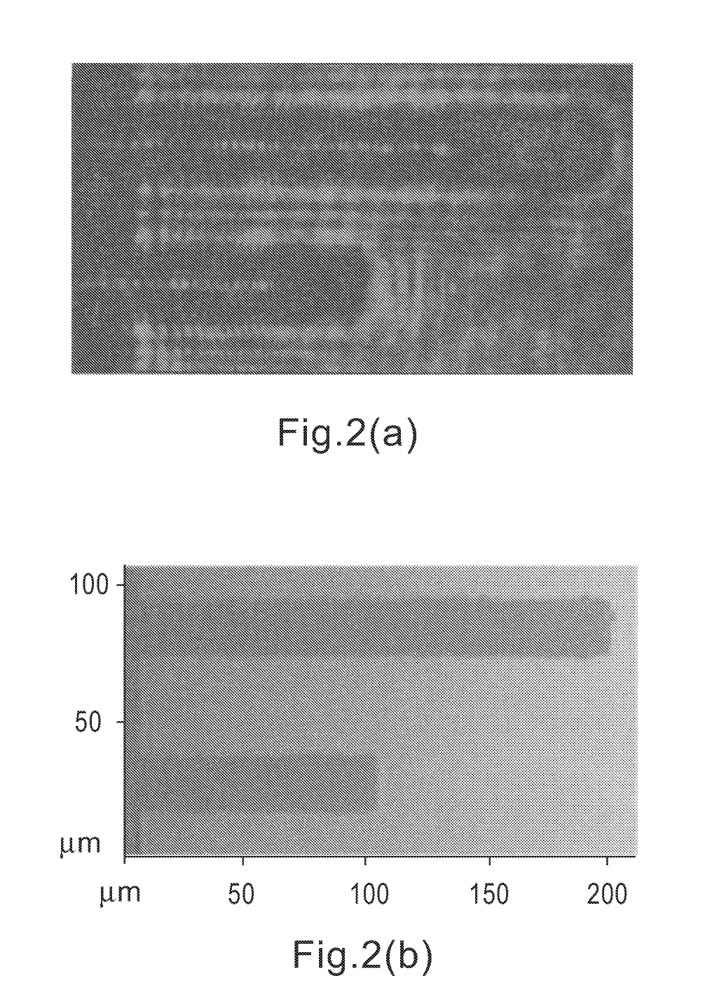

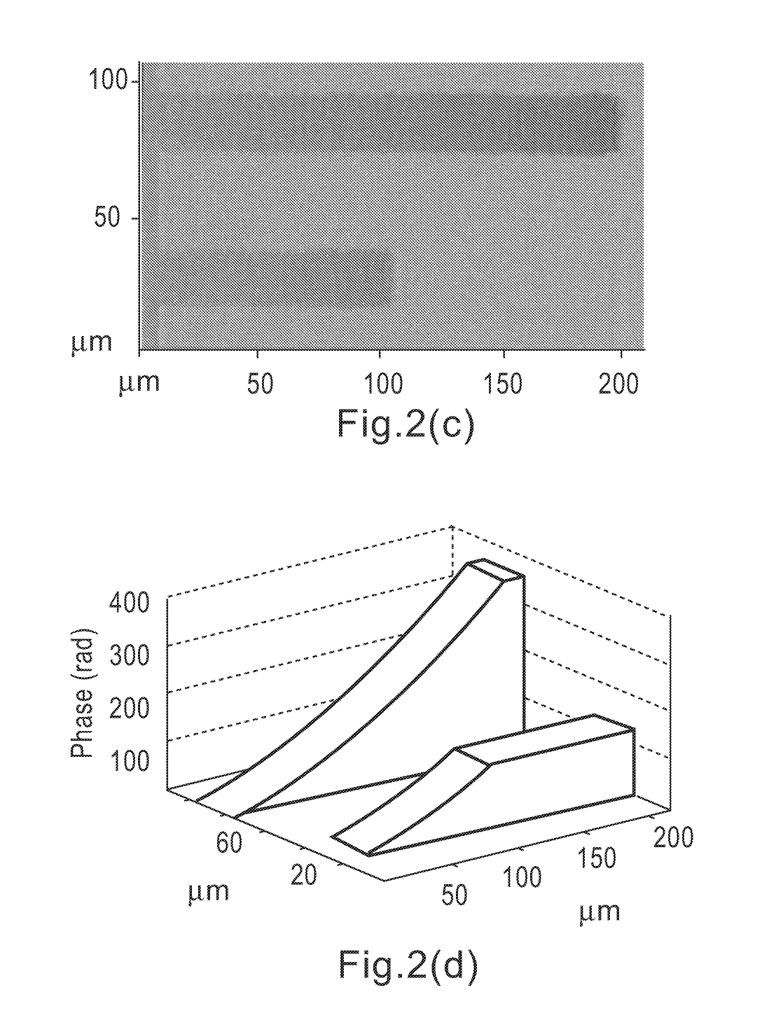

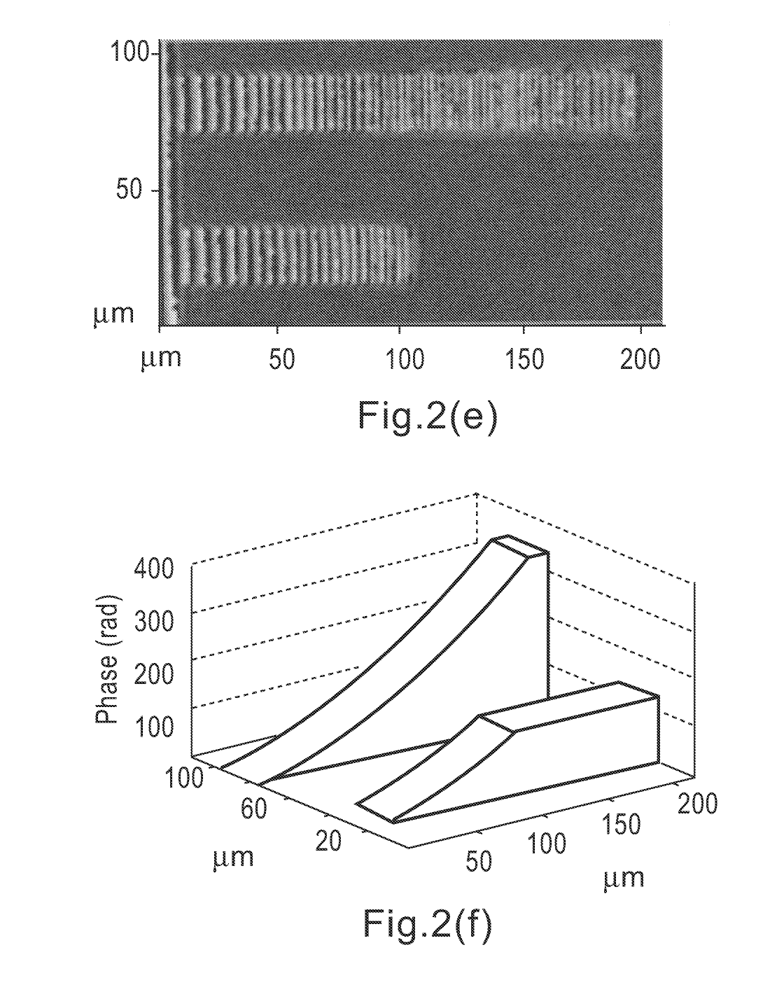

FIG. 2 shows in (a) a digital hologram, in (b) a Phase shearograms in the reconstructed plane and in (c) a Phase shearograms with tilt removed; in (d) a QPM photo of the profile of the MEMS by LSI with DH; in (e) wrapped phase map (modulo 2π) obtained by a double exposure approach (using the procedure described in [16]) and in (f) its unwrapped phase map.

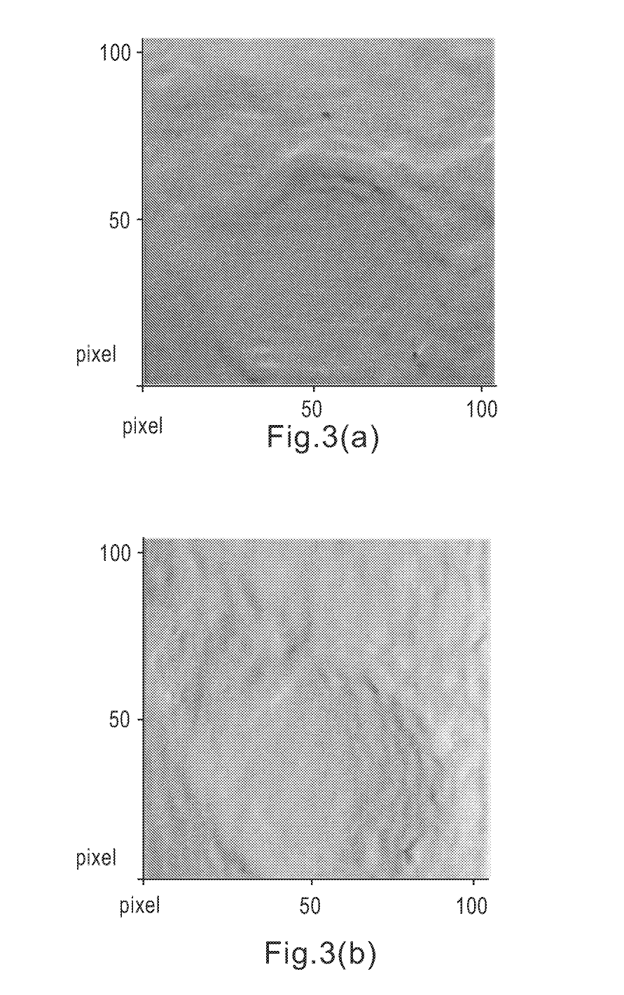

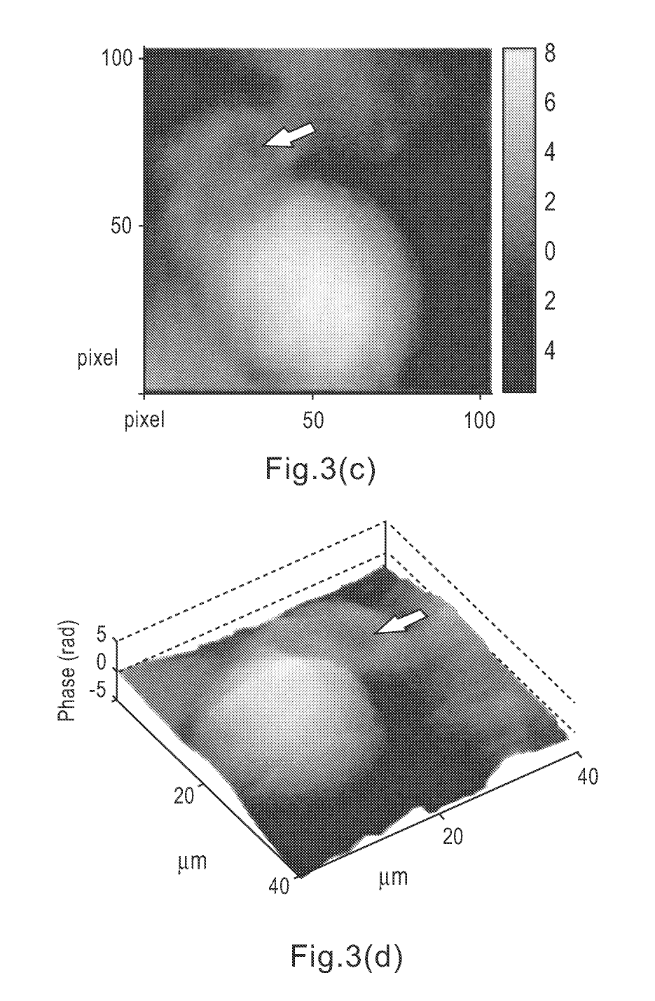

FIG. 3 shows a shearogram along the (a) x and (b) y directions; in (c) it is shown a QPM photo of a cell and in (d) its three-dimensional plot (an arrow indicates a lipid particle detected in the cell line).

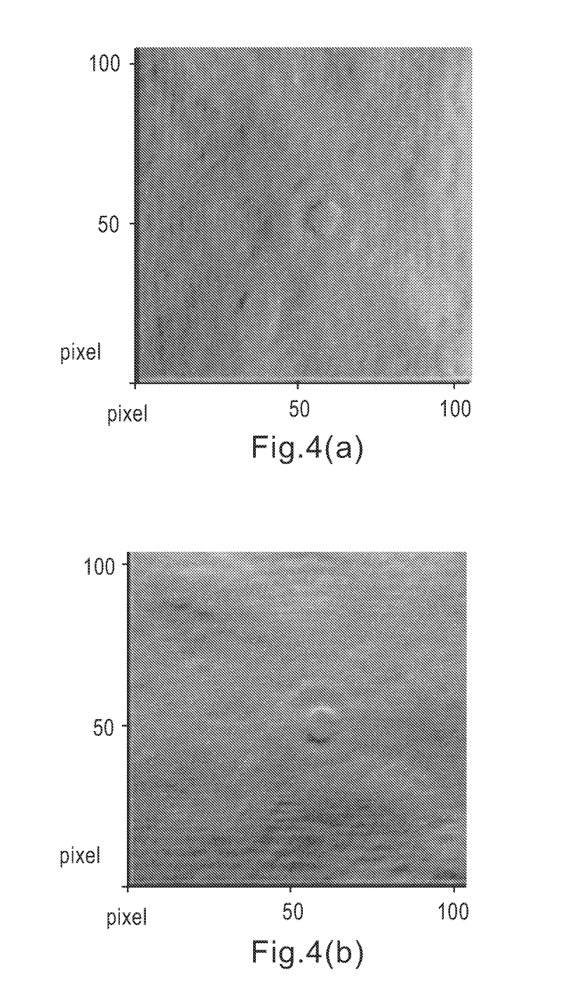

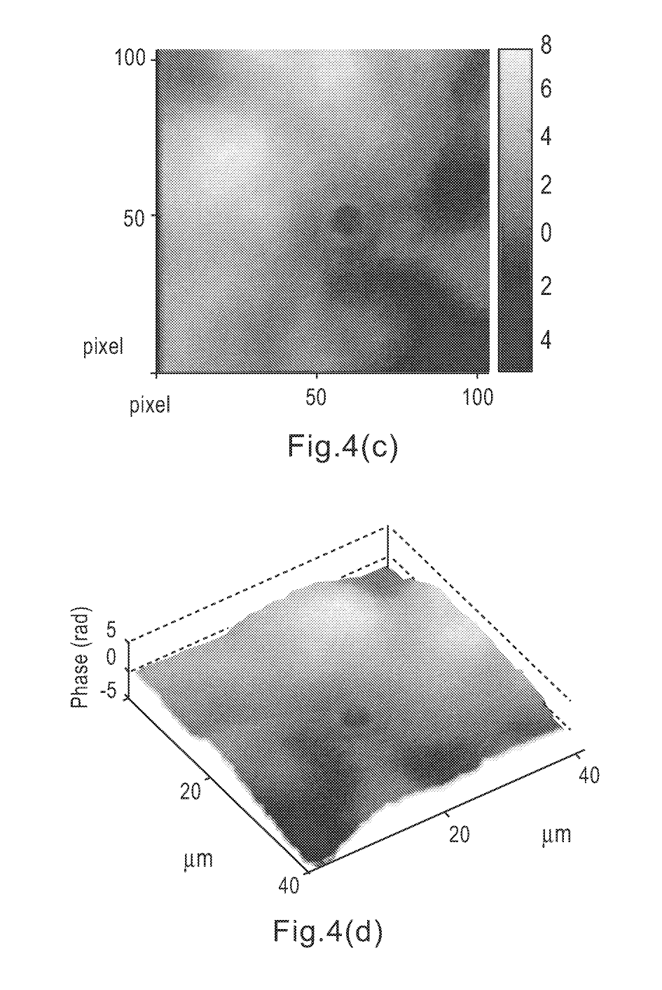

FIG. 4 shows a shearogram along (a) the x and (b) the y directions; in (c) a QPM photo is shown of a cell with lipid accumulation and in (d) its three-dimensional plot.

According to the method of the present invention, by combining the concept of lateral shear interferometry [17] (LSI) and Digital Holography, it is possible to perform QPM by using a true single-image process, or, as it has been named, an intrinsic interferometric configuration [18].

The reconstructed wave front and its replica, obtained digitally by a numerical shift in the image plane, can be subtracted one from the other to produce an interferometric shearogram from which the phase map of the object can be completely retrieved. The process is perfectly analogous to what happens when wavefront aberrations are retrieved in optical testing by LSI [17].

The procedure is simple and can be applied equally well to transparent phase samples or to opaque objects. In the following, the usefulness of the approach for two microscopic objects is demonstrated, a silicon MEMS cantilever and the mouse preadipocyte 3T3-F442A cell line.

FIG. 1 depicts the optical configurations of a DH microscope in transmission (FIG. 1(a)) and in reflection (FIG. 1(b)). If we denote the complex field scattered and (or) reflected by an object O(x,y)=A(x,y)exp[iφ_{O}(x,y)], dove A(x,y) where is the amplitude and φ_{O}(x,y) is the phase, we can write the reconstructed phase map φ(x,y) from a single digital hologram in the following form:

$$ϕ ( x , y ) = {ϕ}_{O} ( x , y ) + \frac{i k}{2 R} ( {x}^{2} + {y}^{2} ) \qquad ( 1 )$$

where the quadratic term that is due to the defocus aberration with curvature radius R has been explicitly taken into account in addition to the object phase.

A strong defocus term comes from the curvature introduced by the microscope objective used to image the sample. Such a term hinders the possibility of obtaining phase φ_{O}(x,y) [15,16]. To determine φ_{O}(x,y) we simply introduce digitally, in the reconstructed image plane, two lateral shears, Δφₓ and Δφ_{y}, in the x and y directions, respectively, of the wavefront of equation (1), namely,

Δφₓ=φ(x,y)−φ(x−sₓ,y) and

Δφ_{y}=φ(x,y)−φ(x,y−s_{y}).

The two shearogram maps Δφₓ and Δφ_{y} are related to the first-order derivative of the wave front if the amount of the shear sₓ and s_{y} is small. Indeed, according to the finite difference approximation approach we have:

$$\begin{matrix}\frac{\partial ϕ ( x , y )}{\partial x} \approx \frac{Δ {ϕ}_{x}}{{s}_{x}} & ( 2 a ) \\ \frac{\partial ϕ ( x , y )}{\partial y} \approx \frac{Δ {ϕ}_{y}}{{s}_{y}} & ( 2 b )\end{matrix}$$

Equations (2a) and (2b) can be written in terms of the finite-difference approximation of object phase distribution φ_{O}(x,y) in the following form:

$$\begin{matrix}\frac{\partial ϕ ( x , y )}{\partial x} \approx \frac{{ϕ}_{O} ( x , y ) - {ϕ}_{O} ( x - {s}_{x} , y )}{{s}_{x}} + \frac{i {ks}_{x} x}{R} + ( {s}_{x} , x ) & ( 3 a ) \\ \frac{\partial ϕ ( x , y )}{\partial y} \approx \frac{{ϕ}_{O} ( x , y ) - {ϕ}_{O} ( x , y - {s}_{y} )}{{s}_{y}} + \frac{i {ks}_{y} y}{R} + ( {s}_{y} , y ) & ( 3 b )\end{matrix}$$

where [symbol] (sₓ,x) and [symbol] (s_{y},y) represents higher orders for other aberrations [18].

Subtraction of the linear term, representing the contribution made by the defocus aberration, from the digital shearograms gives the digital shearograms

Δφ_{O,x}=φ_{O}(x,y)−φ_{O}(x−sₓ,y) and

Δφ_{O,y}=φ_{O}(x,y)−φ_{O}(x,y−s_{y}).

The above-mentioned linear term can be calculated by means of linear fit. In the case one wanted further eliminate also higher order aberrations as they are described in [18] (e.g. coma, spherical aberration), it would be needed a polynomial fit in order to obtain the QPM map. Such fits can be made on the whole or on a portion of the shearogram, so as to eliminate all the aberrations, or considering a line of the hologram where one knows that the object is flat.

From the knowledge of the differences Δφ_{O,x} and Δφ_{O,y} along the x and y directions, object phase distribution φ_{O}(x+Δx,y+Δy) at mesh point (x+Δx,y+Δy) can be determined from its finite difference approximation, i.e.

φ_{O}(x+Δx,y+Δy)≈φ_{O}(x,y)+Δφ_{O}(x,y)Δx+Δφ_{O}(x,y)Δy (4)

by standard integration numerical procedures.

Although one has given here formulae with reference to phase maps, the same formulae are validly applicable to the digital hologram itself or to the reconstructed complex field, provided that at the end, after the shear step, one recovers in any case a phase map to be integrated and from which one takes the calculated aberration(s).

As an applicative example, a digital hologram (1024×1024 pixels, pixel size Δξ=6.7 μm) of a silicon MEMS structure was recorded on a standard monochrome CCD video camera. A linearly polarized green laser (λ=532 nm) was used as a coherent source. The microstructure was observed through a 20×, 0.4 N.A. microscope objective. The hologram was reconstructed at d=130 mm to produce the phase map. The reconstruction pixel was dλ/NΔξ=10 μm. The phase map was sheared and subtracted from itself to yield a shearogram (FIG. 2(b)) according to expression (2a). The shear was limited to a single pixel, sₓ=1. This small amount of shear minimizes the error caused by neglecting higher-order terms in the finite-difference approximation of the phase.

Since the object's surface in this case has a single main curve, only one shearogram is necessary to reconstruct its shape [16].

The linear carrier was removed to produce the image in FIG. 2(c). By applying an integration procedure, we obtained the quantitative phase map by means of expression (4), and we got the map in FIG. 2(d). To validate the procedure, we show in FIG. 2(e) the wrapped phase map that we obtained by using a reference digital hologram and applying the procedure for holographic interferometry described in Ref. 16.

FIG. 2(f) shows a pseudo three-dimensional map of the profile of the MEMS obtained by unwrapping the phase in FIG. 2(e).

Each of the phase maps obtained in both cases appear to be consistent. If a difference is plotted between the two maps, only some small discrepancies are found along the edges of the cantilevers, which appear to be to artefacts introduced by the unwrapping procedure.

In fact, one of the advantages of the proposed method is that unwrapping is not needed in most cases if a small shear is adopted.

The accuracy of the technique is essentially limited by the finite amount of the shear required for obtaining the reconstructed sheared phase map and by the limited spatial resolution of the recording device.

One advantage of the proposed method is that, if the shear is kept small and the phase change between the sheared pixels is less than π, unwrapping can be avoided.

In another applicative example, we have adopted the procedure of LSI and DH to investigate a mouse preadipocyte 3T3-F442A cell line for monitoring the characteristic cell rounding and lipid droplet accumulation in these cells during differentiation. This investigation is aimed at studying a possible role of the endocannabinoid signalling in the control of adipocyte differentiation and function.

By means of quantitative phase microscopy based on DH, we expect to detect lipid droplets and accumulation. Up to now, optical microscopy staining with the dye Oil Red-O was used for such studies [19] but such a method can give false responses.

However it is clear the necessity of a method in which the phase map can be obtained without any reference digital hologram [16] or by a cumbersome digital adjusting procedure [15] because numerous holograms have to be recorded during the observation stage, which can take a long time.

In fact, for the case considered, a cell line differentiates into adipocytes that were once confluent which takes approximately 10 days, and media changes have to be made every 48 h.

FIG. 3 illustrates, as an example, a quantitative phase-contrast map for a cell sample. FIGS. 3(a) and 3(b) show the shearograms obtained with the phase map at an image plane reconstructed from a digital hologram at distance d=100 mm. The shearograms were obtained by subtracting the two digitally sheared wavefronts of sₓ=1 pixel and s_{y}=1 pixel along the x and y directions, respectively. FIG. 3(c) shows the phase map retrieved from the shearograms in FIGS. 3(a) and 3(b). FIG. 3(d) shows a three-dimensional representation of the calculated phase map.

From the QPM analysis of the cell it is possible to investigate the accumulation of lipid droplet by monitoring the variation in optical path length in the phase maps of FIGS. 3(c) and 3(d).

FIG. 4 shows a phase map obtained with higher magnification, in which the presence of a lipid particle is much clearer. Again, FIGS. 4(a) and 4(b) present the shearogram at the image plane lying at reconstruction distance d=100 mm.

It is to be stressed here that the same method can be applied in the case that the experimental apparatus has two CCD cameras which acquires at the same time the hologram with and without shear, the method performing the subtraction of the two images thus obtained from the same experimental apparatus.

One has thus demonstrated that a new and very simple approach can be used to retrieve the phase for QPM analysis by Digital Holography. Phase maps of micro-objects can be obtained by combining the concept of LSI with image reconstruction in DH to maintain all the advantages of the holographic approach. Only one image need be captured during the investigation, and the defocus term is readily removed by the shearing operation.

This offers advantages over previous approaches discussed in the Digital Haplography literature.

One additional advantage is that generally, because of the small amount of shear, no unwrapping is necessary, even in case of a large phase variation [cf. FIGS. 2(c) and 2(e)].

### REFERENCES

[1] A. Barty, K. A. Nugent, D. Paganin, and A. Roberts, Opt. Lett. 23, 817 (1998).
[2] A. Roberts, K. Thorn, M. L. Michna, N. Dragomir, P. Farrel, and G. Baxter, Opt. Lett. 27, 86 (2002).
[3] T. Zhang and I. Yamaguchi, Opt. Lett. 23, 1221 (1998).
[4] A. Stadelmaier and J. H. Massig, Opt. Lett. 25, 1630 (2000).
[5] G. Pedrini, S. Schedin, and H. J. Tiziani, J. Mod. Opt. 48, 1035 (2001).
[6] O. Monnom, F. Dubois, C. Yourassowsky, and J. C. Legros, Appl. Opt. 44, 3827 (2005).
[7] P. Marquet, B. Rappaz, P. Magistretti, E. Cuche, Y. Emery, T. Colomb, and C. Depeursinge, Opt. Lett. 30, 468 (2005).
[8] A. Dakoff, J. Gass, and M. K. Kim, J. Electron. Imaging 12, 643 (2003).
[9] B. Javidi, I. Moon, S. Yeom, and E. Carapezza, Opt. Express 13, 4492 (2005).
[10] L. Xu, X. Peng, J. Miao, and A. K. Asundi, Appl. Opt. 40, 5046 (2001).
[11] P. Ferraro, G. Coppola, S. DeNicola, A. Finizio, and G. Pierattini, Opt. Lett. 28, 1257 (2003).
[12] G. Popescu, L. P. Deflores, J. C. Vaughan, K. Badizadegan, H. Iwai, R. R. Dasari, and M. S. Feld, Opt. Lett. 29, 2503 (2004).
[13] T. Ikeda, G. Popescu, R. R. Dasari, and M. S. Feld, Opt. Lett. 30, 1165 (2005).
[14] C. Joo, T. Akkin, B. Cense, B. H. Park, and J. F. de Boer, Opt. Lett. 30, 2131 (2005).
[15] E. Cuche, P. Marquet, and C. Depeursinge, Appl. Phys. Lett. 38, 6994 (1999).
[16] P. Ferraro, S. DeNicola, A. Finizio, G. Coppola, S. Grilli, C. Magro, and G. Pierattini, Appl. Phys. Lett. 42, 1936 (2003).
[17] S. De Nicola and P. Ferraro, Opt. Commun. 185, 285 (2000).
[18] M. V. Mantravadi, in Optical Shop Testing, 2nd ed., D. Malacara, ed. (Wiley Interscience, 1992), Chap. 4, pp. 123-172.
[19] Z. J. L. Ramirez, M. F. Castro, and H. W. Kuri, Histochem. Cell Biol. 97, 493 (1992).

The preferred embodiments have been above described and some modifications of this invention have been suggested, but it should be understood that those skilled in the art can make variations and changes, without so departing from the related scope of protection, as defined by the following claims.

1. Quantitative phase-contrast digital holography method for the numerical reconstruction of images, comprising the following steps:
A. acquiring a digital hologram of an investigated object;
B. reconstructing the digital hologram in a reconstruction plane;
C. reconstructing the complex field for the digital hologram;
D. obtaining the phase map starting from the complex field;
the method being characterised in that it further comprises the following steps:
E. applying to the digital matrix of any step A, B, C a shear sₓ and/or s_{y} respectively along directions x and/or y;
F. subtracting the matrix obtained in step E from the starting matrix of step E, or vice versa;
G. integrating the obtained matrix along directions x and/or y;
H. calculating at least a defocus aberration term;
I. subtracting said at least a term calculated in step H from the matrix obtained in step Q, the steps G to I being subsequent to step D.

2. Quantitative phase-contrast digital holography method for the numerical reconstruction of images, characterised in that it comprises the following steps:
AA. acquiring two digital holograms of an investigated object, which present a shear sₓ and/or s_{y} respectively along directions x and/or y one with respect to the other;
BB. subtracting one from the other the two digital holograms or their complex field or phase reconstruction, obtaining finally the relevant phase map;
GG. integrating the obtained matrix along directions x and/or y;
HH. calculating at least a defocus aberration term;
II. subtracting said at least a term calculated in step H from the matrix obtained in step GG,
the steps GG to II being subsequent to step BB.

3. Method according to claim 1, characterised in that the shear is applied directly to the digital hologram of step A.

4. Method according to claim 1, characterised in that the shear is applied directly to the digital hologram of step B.

5. Method according to claim 1, characterised in that the shear is applied directly to the digital hologram of step C.

6. Method according to claim 1, characterised in that said reconstruction plane is the image plane at distance d from the object.

7. Method according to any claim 1, characterised in that said reconstruction plane is the hologram plane.

8. Method according to claim 1, characterised in that in step G, the phase distribution of the object φₒ(x+Δx,y+Δy) in the point (x+Δx,y+Δy) can be determined with finite difference approximation, i.e.:
φₒ(x+Δx,y+Δy)≈φₒ(x,y)+Δφₒ(x,y)Δx+Δφₒ(x,y)Δy
by means of standard numerical integration procedures.

9. Method according to claim 1, characterised in that sₓ and/or s_{y}=1 pixel.

10. Method according to claim 1, characterised in that said at least an aberration term is calculated on the basis of the information of the same digital matrix obtained after the subtraction or integration.

11. Method according to claim 10, characterised in that an aberration term is calculated by a linear fit.

12. Method according to claim 10, characterised in that more terms are calculated by polynomial fit.

13. Method according to claim 1, characterised in that before step G, a low-pass filter is applied.

14. Apparatus of digital holography, comprising a CCD camera suited to acquire digital holograms, as well as an electronic elaboration unit of such digital holograms, characterised in that said electronic elaboration unit carries out on an acquired digital hologram the method according to claim 1, in order to obtain a phase map devoid of aberration disturbances due to the apparatus optics.

15. Apparatus of digital holography, comprising two CCD cameras suited to acquire digital holograms, as well as an electronic elaboration unit of such digital holograms, characterised in that said two CCD cameras acquires directly two holograms which present a shear one with respect to the other, said electronic elaboration unit carrying out the method according to claim 2, in order to obtain the phase map devoid of aberration disturbances due to apparatus optics.

16. Method according to claim 2, characterised in that in step GG, the phase distribution of the object φₒ(x+Δx,y+Δy) in the point (x+Δx,y+Δy) can be determined with finite difference approximation, i.e.:
Δφₒ(x+Δx,y+Δy)≈φₒ(x,y)+Δφₒ(x,y)Δx+Δφₒ(x,y)Δy
by means of standard numerical integration procedures.

17. Method according to claim 2, characterised in that before step GG, a low-pass filter is applied.
